(19) United States
(12) Patent Application Publication
(10) Pub. No.: US 2011/0028152 A1
(43) Pub. Date: Feb. 3, 2011

(54) HANDOVER METHOD AND CONTROL APPARATUS USING THE HANDOVER METHOD

(75) Inventor: Makoto Okada, Gifu (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Fushimi-ku, KYOTO (JP)

(21) Appl. No.: 12/744,317

(22) PCT Filed: Oct. 31, 2008
(86) PCT No.: PCT/JP2008/003128

§ 371 Date: Oct. 4, 2010

(30) Foreign Application Priority Data
Nov. 22, 2007 (JP) 2007-303123

(51) Int. Cl. H04W 36/32

(52) U.S. Cl. 455/437

(57) ABSTRACT

A receiving unit receives a first list showing base station apparatuses picked up by a terminal apparatus. The first list is attendant to a request for position registration sent from the terminal apparatus to a first base station apparatus. A selector compares the received first list with a second list showing base station apparatuses subscribed to by the terminal apparatus, and selects an already-subscribed second base station apparatus picked up by the terminal apparatus. An instruction unit has the first base station apparatus instruct the terminal apparatus to perform a handover to the second base station apparatus selected by the selector.

### TECHNICAL FIELD

The present invention relates to a handover technology and more particularly to a handover method using shifts between base station apparatuses and a control apparatus and a terminal apparatus using said method.

### BACKGROUND TECHNOLOGY

In a mobile phone system, there are actually blind zones where radio waves do not reach even in areas designated as a service area on the map. It is desirable that the blind zones be smaller if the mobile phone system is to be of greater utility. The IMCS (In Mobile

Communication System) is an indoor base station system developed specifically to eliminate indoor blind zones. Further, there is also a base station system called a simplified IMCS. This simplified IMCS is a system that performs signal amplification at the wireless level bidirectionally and proves effective when an antenna is installed in a location where it is difficult to get a connection to a mobile phone network. Also, the simplified IMCS permits connection to only the terminal apparatuses that have registered in advance, out of the terminal apparatuses having made position registration to the simplified IMCS. More specifically, a decision is made on the network side based on the terminal information of terminal apparatuses which have made position registration to the simplified IMCS, and a connection will be cut if it is a non-subscribing terminal apparatus.

[Patent Document 1] Japanese Patent Publication No. 2005-109570.

### DISCLOSURE OF THE INVENTION

### Problems to be Solved by the Invention

In a wireless communication system, there are cases where two kinds of base station apparatuses are installed. One is a microcell base station apparatus, and the other is a nanocell base station apparatus. In a comparison between these two, the former may have a higher transmission power and wider service area than the latter. Also, as with the above-described IMCS or the like, the nanocell base station apparatus is installed in such a manner as to cover the blind zone of the microcell base station apparatus. Further, in recent years, attention is being directed to the structuring of femtocells by use of the nanocell base station apparatus. The femtocell is a communication mode in which a nanocell base station apparatus is installed within a home in connection with an carrier's network via a broadband connection. In such a case, the nanocell base station apparatus normally allows connection to previously subscribing terminal apparatuses only.

And there are cases where the service area of a nanocell base station apparatus installed within a home overlaps with the service area of a microcell base station apparatus. In such a case, the network operator may find it desirable that the terminal apparatus be preferentially connected to the nanocell base station apparatus. However, as mentioned above, the microcell base station apparatus uses a stronger transmission power than the nanocell base station apparatus. As a result, the terminal apparatus may sometimes select the microcell base station apparatus despite its capability to connect to the nanocell base station apparatus. To solve this problem, it can be so arranged that identification information on the nanocell base station apparatus is stored in the terminal apparatus and the nanocell base station apparatus is selected preferentially from among the picked-up base station apparatuses. In this case, however, whenever the terminal apparatus used by a user changes, identification information on the nanocell base station apparatus must be stored in the new terminal apparatus.

The present invention has been made in view of the foregoing circumstances, and a purpose thereof is to provide a communication technology that can readily realize preferential selection of a nanocell base station apparatus over a microcell base station apparatus.

### Means for Solving the Problems

In order to resolve the above problems, a control apparatus according to one embodiment of the present invention comprises: a receiving unit configured to receive a first list showing base station apparatuses picked up by a terminal apparatus, the first list being attendant to a request for position registration sent from the terminal apparatus to a first base station apparatus; a selector configured to select a subscribed second base station apparatus picked up by the terminal apparatus by comparing the first list received by the receiving unit with a second list showing base station apparatuses subscribed to by the terminal apparatus; and an instructing unit configured to have the first base station apparatus instruct the terminal apparatus to perform a handover to the second base station apparatus selected by the selector.

Another embodiment of the present invention relates to a terminal apparatus. The terminal apparatus performs position registration and the terminal apparatus comprises: a selector configured to select a first base station apparatus whose position registration is to be requested, from among picked-up base station apparatuses; a transmitter configured to require the position registration of the first base station apparatus selected by the selector and configured to transmit a first list showing the picked-up base station apparatuses; a receiver configured to receive an instruction to perform a handover from the first base station apparatus, whose position registration has been requested by the transmitter, to a second base station apparatus, the second base station apparatus having been selected as a result of comparison between the first list and a second list showing base station apparatuses to which the terminal apparatus have subscribed; and a handover processing unit configured to perform a handover to the second base station apparatus, based on the instruction received by the receiver.

Still another embodiment of the present invention relates to a handover method. The handover method comprises: receiving a first list showing base station apparatuses picked up by a terminal apparatus, the first list being attendant to a request for position registration sent from the terminal apparatus to a first base station apparatus; selecting a subscribed second base station apparatus picked up by the terminal apparatus, by comparing the received first list with a second list showing base station apparatuses subscribed to by the terminal apparatus; and causing the first base station apparatus to instruct the terminal apparatus to perform a handover to the selected second base station apparatus.

Still another embodiment of the present invention relates also to a handover method. The handover method comprises: selecting a first base station apparatus whose position registration is to be requested, from among picked-up base station apparatuses; requiring the position registration of the selected first base station apparatus and transmitting a first list showing the picked-up base station apparatuses; receiving an instruction to perform a handover from the first base station apparatus, whose position registration has been requested, to a second base station apparatus, the second base station apparatus having been selected as a result of comparison between the first list and a second list showing base station apparatuses to which the terminal apparatus have subscribed; and performing a handover to the second base station apparatus, based on the received instruction.

Optional combinations of the aforementioned constituting elements, and implementations of the invention in the form of methods, apparatuses, systems, recording mediums, computer programs and so forth may also be effective as additional modes of the present invention.

### EFFECT OF THE INVENTION

The present invention promptly readily realizes preferential selection of a nanocell base station apparatus over a microcell base station apparatus.

### BRIEF DESCRIPTION OF THE DRAWINGS

FIG. 1 shows a structure of a communication system according to an exemplary embodiment of the present invention.

FIGS. 2A shows a structure of a frame in the communication system of FIG. 1.

FIGS. 2B shows a structure of a frame in the communication system of FIG. 1.

FIGS. 2C shows a structure of a frame in the communication system of FIG. 1.

FIG. 3 shows an assignment of subchannels in the communication system of FIG. 1.

FIG. 4 shows a structure of the microcell base station apparatus of FIG. 1.

FIG. 5 shows a structure of the terminal apparatus of FIG. 1.

FIG. 6 shows a data structure of a base station list generated by the list generator of FIG. 5.

FIG. 7 shows a structure of the control apparatus of FIG. 1.

FIG. 8 illustrates a data structure of a subscription list stored in the buffer of FIG. 7.

FIG. 9 is a sequence diagram showing a handover procedure in the communication system of FIG. 1.

FIG. 10 is a flowchart showing a handover procedure in the terminal apparatus of FIG. 5.

FIG. 11 is a flowchart showing a handover procedure in the microcell base station apparatus of FIG. 4.

FIG. 12 is a flowchart showing a handover procedure in the control apparatus of FIG. 7.

### DESCRIPTION OF THE REFERENCE NUMERALS

10 Microcell base station apparatus
12 Terminal apparatus
14 Network
16 Control apparatus
20 RF unit
22 Baseband processing unit
24 Modem unit
26 IF unit
28 Radio control unit
30 Storage
32 Control channel decision unit
38 Radio resource allocation unit
50 Nanocell base station apparatus
52 Nanocell server
60 RF unit
62 Modem unit
64 IF unit
66 Control unit
68 Acquisition unit
70 Selector
72 List generator
74 Signal generator
76 Handover processing unit
80 IF unit
82 Buffer
84 Control unit
86 Receiving unit
88 Selector
90 Position registration unit
92 Instruction unit
100 Communication system

### BEST MODE FOR CARRYING OUT THE INVENTION

The present invention will be first outlined before the specifics thereof are explained. The exemplary embodiments of the invention relate to a communication system comprised of a base station apparatus, a terminal apparatus, and a control apparatus. It is to be noted here that a base station apparatus includes a microcell base station apparatus and a nanocell base station apparatus.

While the microcell base station apparatus can connect all the terminal apparatuses, the nanocell base station apparatus can connect only the terminal apparatuses that have subscribed in advance. There are cases where the service area of a microcell base station apparatus overlaps with the service area of the nanocell base station apparatus.

In such a case, the telecommunications carrier may find it desirable that the nanocell base station apparatus be selected preferentially. Also, in order to make the structure of or changes to the terminal apparatus simpler, it is desired that the list of nanocell base station apparatuses subscribed to by the terminal apparatus be not stored in the terminal apparatus. To meet these requirements, the communication system according to the present exemplary embodiment is configured as described below.

The terminal apparatus picks up base station apparatuses by receiving broadcast signals (beacons) sent by the base station apparatuses. Also, the terminal apparatus generates a list of base station apparatuses the terminal apparatus has picked up (hereinafter referred to as “base station list”). The terminal apparatus selects a base station apparatus having the greatest received signal strength of beacon out of the base station apparatuses picked up by the terminal apparatus. Here it is assumed that a microcell base station apparatus is selected. The terminal apparatus transmits a request for position registration to the selected microcell base station apparatus and at the same time transmits a base station list. The microcell base station apparatus performs a processing of position registration. Also, the microcell base station apparatus outputs the base station list to the control apparatus. The control apparatus, which has stored in advance a list of nanocell base station apparatuses already subscribed to by the terminal apparatus (hereinafter referred to as “subscription list”), compares the base station list received with the subscription list. Further, the control apparatus selects an already-subscribed nanocell base station apparatus picked up by the terminal apparatus and conveys the result to the microcell base station apparatus. The microcell base station apparatus indicates a handover to the selected nanocell base station apparatus, to the terminal apparatus. The terminal apparatus performs a processing of a handover from the microcell base station apparatus to the nanocell base station apparatus.

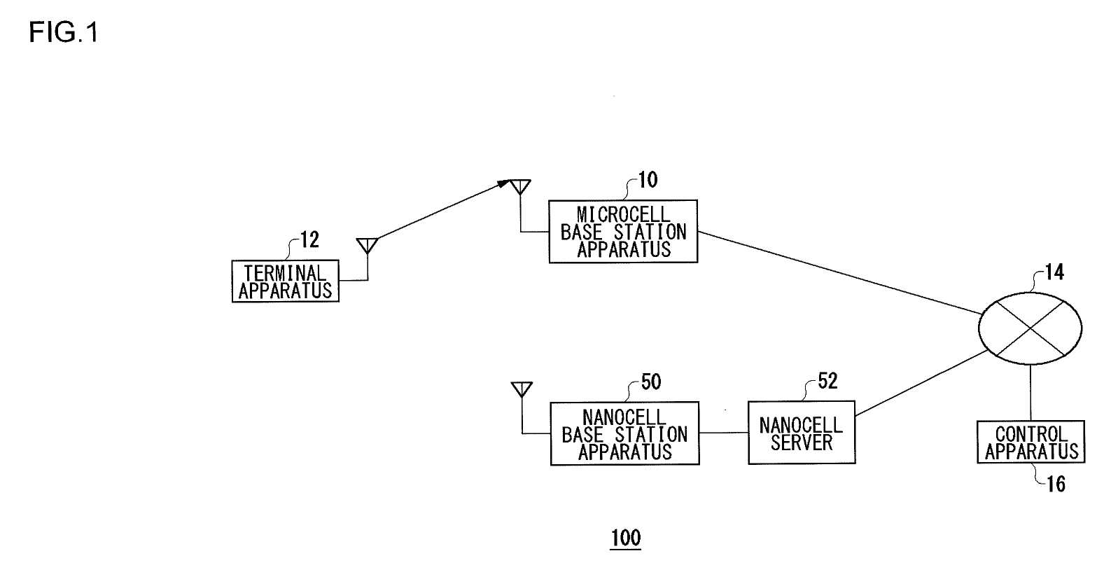

FIG. 1 shows a structure of a communication system 100 according to an exemplary embodiment of the present invention. The communication system 100 includes a microcell base station apparatus 10, a terminal apparatus 12, a network 14, a control apparatus 16, a nanocell base station apparatus 50, and a nanocell server 52.

The microcell base station apparatus 10 has one end thereof connected to the terminal apparatus 12 via a wireless network and the other end thereof connected to a wired network 14. The microcell base station apparatus 10 performs communications with a plurality of terminal apparatuses 12 by assigning communication channels to the plurality of terminal apparatuses 12. More specifically, the microcell base station apparatus 10 sends out a broadcast signal, and the terminal apparatus 12 recognizes the presence of the microcell base station apparatus 10 by receiving the broadcast signal. Then the terminal apparatus 12 transmits a request signal for position registration to the microcell base station apparatus 10. Also, the terminal apparatus 12 transmits a request signal for channel assignment to the microcell base station apparatus 10, and in response to the request signal received, the microcell base station apparatus 10 assigns a communication channel to the terminal apparatus 12.

Also, the microcell base station apparatus 10 transmits information on the communication channel assigned to the terminal apparatus 12, and the terminal apparatus 12 performs communications with the microcell base station apparatus 10 using the assigned communication channel. As a result, data transmitted from the terminal apparatus 12 is outputted to the network 14 via the microcell base station apparatus 10 and finally received by a not-shown communication apparatus connected to the network 14. Also, data is transmitted in the direction of the terminal apparatus 12 from the communication apparatus. Note here that the communication system 100 is compatible with an OFDMA (Orthogonal Frequency Division Multiple Access) system. OFDMA is a technique for frequency multiplexing a plurality of terminal apparatuses using OFDM. In OFDMA like this, a subchannel is constituted by multiple subcarriers, and a plurality of subchannels are frequency-division multiplexed.

Also, combined with TDMA, a multicarrier signal is divided into a plurality of time slots on the time axis. In other words, each frame is formed by time-division multiplexing a plurality of time slots, whereas each time slot is formed by frequency-division multiplexing a plurality of subchannels. Also, each subchannel is formed by multicarrier signals. In the above description, a communication channel is identified by a combination of subchannels and a time slot. Therefore, the microcell base station apparatus 10 performs communications with the terminal apparatus 12 by assigning the subchannels in at least one time slot to the terminal apparatus 12.

The nanocell base station apparatus 50 and the nanocell server 52 have functions identical with those of the microcell base station apparatus 10. Note here that the nanocell base station apparatus 50 and the nanocell server 52 differ from the microcell base station apparatus 10 in that they have a smaller transmission signal strength and they can connect to the subscribed terminal apparatuses 12 only. Also, the processings done by the microcell base station apparatus 10 are divided into those done by the nanocell base station apparatus 50 and those done by the nanocell server 52, and the nanocell server 52 executes higher-layer processings than those of the nanocell base station apparatus 50. Also, the nanocell server 52 is also connected to other not-shown nanocell base station apparatuses 50 and therefore executes higher-layer processings for the plurality of nanocell base station apparatuses 50.

The terminal apparatus 12 is capable of connecting to microcell base station apparatuses 10 and nanocell base station apparatuses 50, and picks up the microcell base station apparatuses 10 and the nanocell base station apparatuses 50 by receiving broadcast signals therefrom. Now, based on the picked-up results, the terminal apparatus 12 generates a base station list as mentioned previously and transmits the base station list to the microcell base station apparatus 10 whose position has already been registered. The terminal apparatus 12 then performs a handover to a nanocell base station apparatus 50 when the terminal apparatus 12 receives an instruction to perform a handover to the nanocell base station apparatuses 50 from the microcell base station apparatus 10.

The control apparatus 16 makes a connection to the microcell base station apparatus 10 and the nanocell server 52 via the network 14. Note that other not-shown microcell base station apparatuses 10 and nanocell base station apparatuses 50 are also connected to the control apparatus 16. As a result, a paging area is formed by a plurality of microcell base station apparatuses 10 and nanocell base station apparatuses 50 connected to the control apparatus 16. Also, the control apparatus 16 performs position registration processings on terminal apparatuses 12 connected to the microcell base station apparatuses 10 and nanocell base station apparatuses 50.

Note that the position registration processing may be a known art and therefore the description thereof is omitted here. It can thus be said that the control apparatus 16 controls the paging area.

Also, as will be discussed in detail later, the control apparatus 16, which stores the aforementioned subscription list, obtains a base station list from the terminal apparatus 12 via the microcell base station apparatus 10. The control apparatus 16 selects an already-subscribed nanocell base station apparatus 50 picked up by the terminal apparatus 12 by comparing the base station list with the subscription list. The control apparatus 16 outputs an instruction of a handover to the selected nanocell base station apparatus 50, to the microcell base station apparatus 10. Upon receipt of the instruction, the microcell base station apparatus 10 instructs the terminal apparatus 12 to perform the handover.

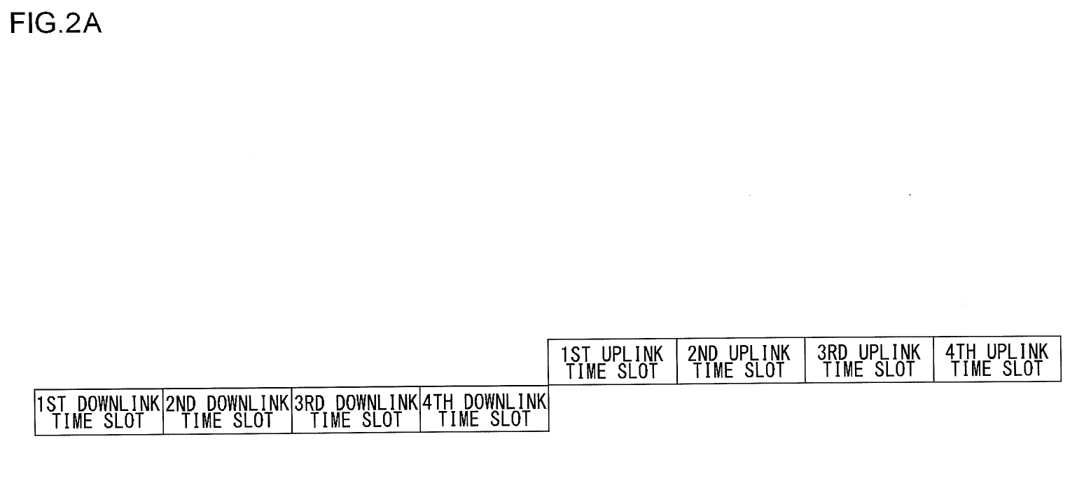

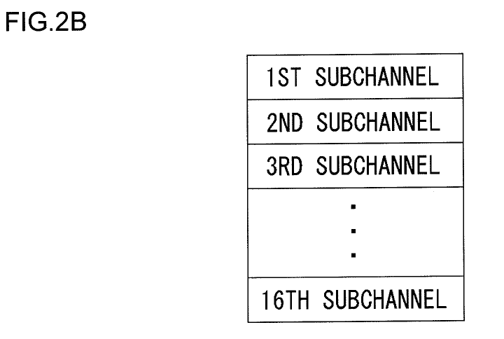

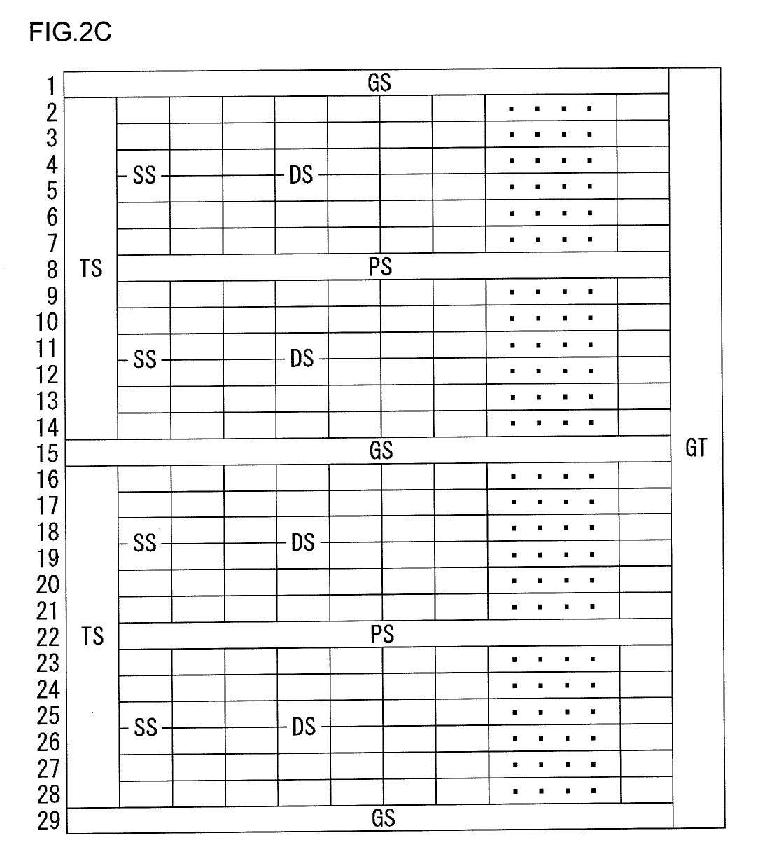

FIGS. 2A to 2C each shows a structure of a frame in the communication system 100. The horizontal direction in each of FIGS. 2A to 2C corresponds to time. A frame is constituted by eight time slots which are time-multiplexed.

The eight time slots are composed of four downlink time slots and four uplink time slots. Here, the four uplink time slots are denoted as “first uplink time slot” through “fourth uplink time slot”, whereas the four downlink time slots are denoted as “first downlink time slot” through “fourth downlink time slot”. The frame as shown in each of FIGS. 2A to 2C is repeated contiguously.

Note that the structure of a frame is not limited to that of FIG. 2A and, for example, a frame may be constituted by four time slots or sixteen time slots. For the clarity of explanation, a description will be given hereinbelow of the structure of a frame assuming that the frame is constituted as shown in FIG. 2A. For the simplicity of explanation, the structure of an uplink time slot and that of a downlink time slot are identical to each other. Accordingly, if a description is given of the uplink time slots only or the downlink time slots only, the same description will be valid for the other time slots. A plurality of contiguous frames form a super frame wherein each of the frames is one as shown in FIG. 2A. Assume herein, for example, that a super frame is constituted by “twenty” frames.

FIG. 2B shows a structure of one of the time slots shown in FIG. 2A. The vertical direction of FIG. 2B corresponds to the frequency axis. As shown in FIG. 2B, one time slot is formed by frequency-multiplexing “16” subchannels of “first subchannel” through “sixteenth subchannel”. Such a plurality of subchannels as these are frequency-division multiplexed. Since each time slot is constituted as shown in FIG. 2B, the aforementioned communication channel is identified by the combination of a time slot and a subchannel. Also, a frame construction corresponding to one of the subchannels shown in FIG. 2B may be one shown in FIG. 2A. Note that the number of subchannels assigned to each time slot may not be “16”. Assume here that the allocation of subchannels in the uplink time slots and the allocation of subchannels in the downlink time slots are identical to each other. Assume also that at least one broadcast signal (beacon) is assigned to each super frame. For example, beacon is assigned to a subchannel in a time slot among a plurality of downlink time slots contained in a super frame.

FIG. 2C shows a structure of one of the subchannels shown in FIG. 2B. FIG. 2C corresponds to the aforementioned packet signal. Similar to FIGS. 2A and 2B, the horizontal direction thereof corresponds to the time axis, whereas the vertical direction thereof corresponds to the frequency axis. The numbers “1” to “29” are given along the frequency axis. These numbers indicate subcarrier numbers. In this manner, a subchannel is constituted by multicarrier signal, in particular, OFDM signal. “TS” in FIG. 2C corresponds to a training signal, which is constituted by a known value. “SS” corresponds to a symbol signal. “GS” corresponds to a guard symbol and no substantial signal is assigned here. “PS” corresponds to a pilot symbol, which is constituted by a known value. “DS” corresponds to a data symbol, which is data to be transmitted. “GT” corresponds to a guard time and no substantial signal is assigned here.

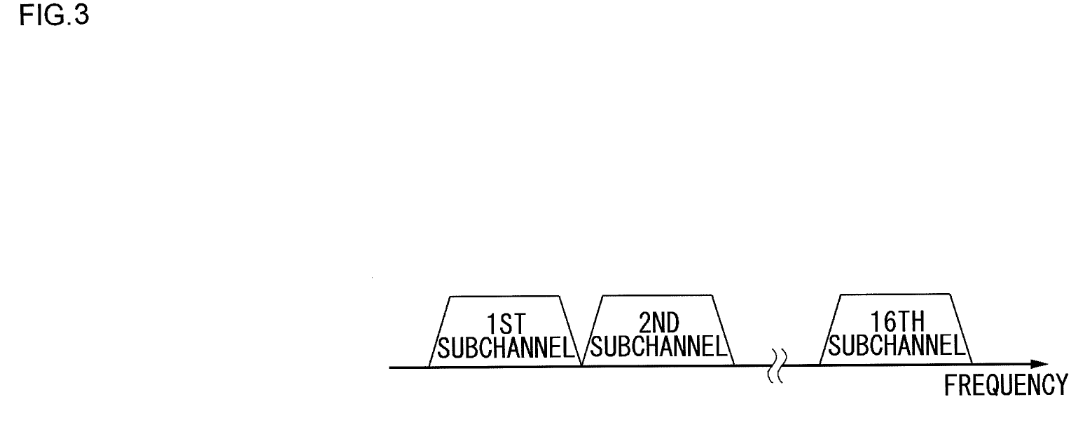

FIG. 3 shows an assignment of subchannels in the communication system 100. In FIG. 3, the horizontal axis represents the frequency axis and illustrates the spectrum for time slots shown in FIG. 2B. As described above, sixteen subchannels composed of the first subchannel to the sixteenth subchannel are frequency-division multiplexed in each time slot. Each subchannel is constituted by multicarrier signal, namely, OFDM signal here.

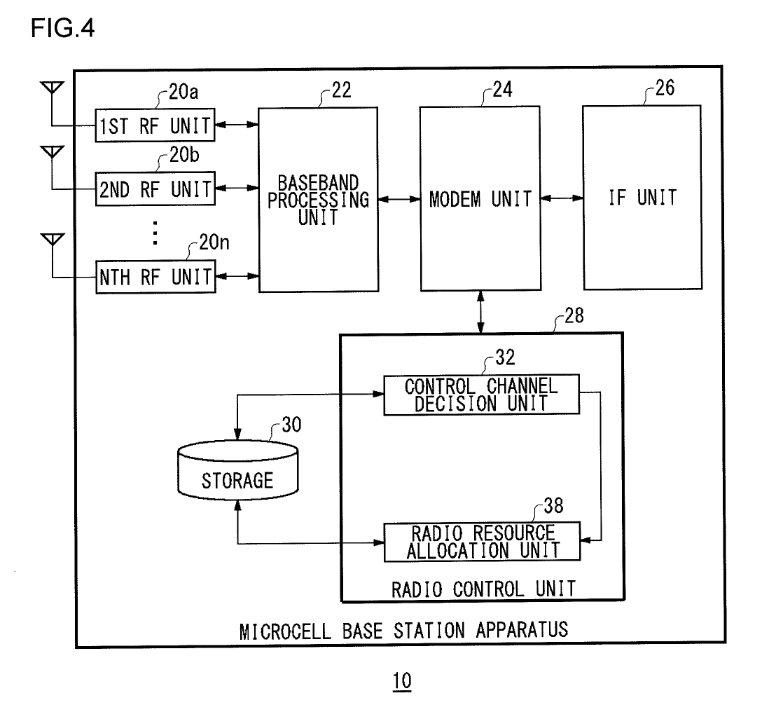

FIG. 4 shows a structure of the microcell base station apparatus 10. The microcell base station apparatus 10 includes a first RF unit 20a, a second RF unit 20b, . . . and an Nth RF unit 20n, which are generically referred to as “RF unit 20” or “RF units 20”, a baseband processing unit 22, a modem unit 24, an IF unit 26, a radio control unit 28, and a storage 30. The radio control unit 28 includes a control channel decision unit 32 and a radio resource allocation unit 38.

As a receiving processing, the RF unit 20 performs frequency conversion on radiofrequency multicarrier signals received from the not-shown terminal apparatus 12 so as to produce baseband multicarrier signals. Here, the multicarrier signal is formed as shown in FIG. 3 and corresponds to an uplink time slot as shown in FIG. 2A. Further, the RF unit 20 outputs the baseband multicarrier signal to the baseband processing unit 22. The baseband multicarrier signal, which is composed of in-phase components and quadrature components, shall generally be transmitted by two signal lines. For the clarity of Figures, the baseband multicarrier signal is presented here by a single signal line only. An AGC unit and an A-D conversion unit are also included in the RF unit 20.

As a transmission processing, the RF unit 20 performs frequency conversion on the baseband multicarrier signals inputted from the baseband processing unit 22 and thereby produces radiofrequency multicarrier signals. Further, the RF unit 20 transmits the radiofrequency multicarrier signals. The RF unit 20 transmits the multicarrier signals using the same radio-frequency band as that of the received multicarrier signals. That is, assume that TDD (Time Division Duplex) is in use as shown in FIG. 2A. A PA (Power Amplifier) and a D-A conversion unit are also included in the RF unit 20.

As a receiving processing, the baseband processing unit 22 receives the input of baseband multicarrier signals from a plurality of RF units 20, respectively. Since the baseband multicarrier signal is a time-domain signal, the baseband processing unit 22 converts the time-domain signal into a frequency-domain signal through FFT so as to perform adaptive array signal processing on the frequency-domain signals. Also, the baseband processing unit 22 sets timing synchronization, namely FFT windows, and removes the guard intervals. A known art may be used for the timing synchronization or the like and therefore the description thereof is omitted here. The baseband processing unit 22 outputs the results of the adaptive array signal processing to the modem unit 24. As a transmission processing, the baseband processing unit 22 receives the input of the frequency-domain multicarrier signals and perform spreading processing on them by a weight vector.

As a transmission processing, the baseband processing unit 22 converts the frequency-domain signals, which are the frequency-domain multicarrier signals inputted from the modem unit 24, into the time domain through IFFT, and outputs the thus converted time-domain signal to the RF unit 20. The baseband processing unit 22 also appends guard intervals but the description thereof is omitted here. Here, as shown in FIG. 2B, the frequency-domain signal contains a plurality of subchannels, and each of the subchannels contains multiple subcarriers as in the vertical direction shown in FIG. 2C. For the clarity of Figure, the frequency-domain domain signal is arranged in the order of the subcarrier numbers, and forms serial signals.

As a receiving processing, the modem unit 24 demodulates the frequency-domain multicarrier signals outputted from the baseband processing unit 22. The multicarrier signals converted into the frequency domain have components corresponding respectively to a plurality of subcarriers as shown in FIG. 2B and FIG. 2C. Demodulation is done on a subcarrier-by-subcarrier basis. The modem unit 24 outputs the demodulated signals to the IF unit 26. As a transmission processing, the modem unit 24 carries out modulation. The modem unit 24 outputs the modulated signals to the baseband processing unit 22 as frequency-domain multicarrier signals.

As a receiving processing, the IF unit 26 receives a demodulation result from the modem unit 24 and separates the demodulation result in units of terminal apparatus 12. That is, the demodulation result is composed of a plurality of subchannels, as shown in FIG. 3. Accordingly, if each subchannel is allocated to each terminal apparatus 12, the demodulation result will contain signals from a plurality of terminal apparatuses 12. The IF unit 26 separates such a demodulation result for each terminal apparatus 12. The IF unit 26 outputs the thus separated demodulation results to the not-shown network 14. In so doing, the IF unit 26 executes transmission according to information, with which to identify the destination, such as IP (Internet Protocol) address.

As a transmission processing, the IF unit 26 receives the input of data for the plurality of terminal apparatuses 12, from the not-shown network 14. The IF unit 26 allocates data to the subchannels and forms multicarrier signal from a plurality of subchannels. That is, as shown in FIG. 3, the IF unit 26 provides the multicarrier signal composed of a plurality of subchannels. Assume herein that the subchannels to which data is to be allocated are determined beforehand as in FIG. 2C and the instructions as to the allocation are received from the radio control unit 28. The IF unit 26 outputs the multicarrier signals to the modem unit 24.

The radio control unit 28 controls the operation of the microcell base station apparatus 10. As shown in FIGS. 2A to 2C and FIG. 3, the radio control unit 28 defines time slots formed by the frequency multiplexing of a plurality of subchannels and defines frames formed by the time multiplexing of a plurality of time slots. The radio control unit 28 instructs the modem unit 24 and the like to form the packet signals, and sends out the broadcast signals. The control channel decision unit 32 allocates the broadcast signals to the subchannels. Here, as described above, broadcast signal or beacon is a signal that contains information used to control communications performed with the terminal apparatus 12. The broadcast signal or the like signal is said to be more important than the packet signal containing the data. The control channel decision unit 32 selects a predetermined subchannel by referencing the storage 30. Also, the control channel decision unit 32 conveys the selected subchannel to the radio resource allocation unit 38.

The radio resource allocation unit 38 allocates the sub-channel to the broadcast signal according to the notification sent from the control channel decision unit 32.

In cooperation with the radio control unit 28, the storage 30 stores information on the sub-channel allocated to the terminal apparatus 12 and information on a control channel. After transmitting the broadcast signal, the radio resource allocating unit 38 receives a request for position registration and a request for the allocation of subchannels sent from the not-shown terminal apparatus 12, via the RF unit 20 through modem unit 24. If the radio resource allocation unit 38 receives the request for position registration and/or the base station list, the radio resource allocation unit 38 will transmit them to the not-shown control apparatus 16. Though a ranging processing is performed between the microcell base station apparatus 10 and the terminal apparatus 12 before the subchannel allocation request is received, the description thereof is omitted here. The subchannel allocation request is also called a radio resource acquisition request. The radio resource allocation unit 38 allocates the subchannel to the terminal apparatus 12 that has received the allocation request.

Here, the radio resource allocation unit 38 allocates subchannels contained in the uplink time slots and the downlink time slots, to the terminal apparatus 12. In particular, assume that the allocation of subchannels in the uplink time slots and the allocation of subchannels in the downlink time slots are done in a symmetrical manner to each other. When allocating the subchannels, the radio resource allocation unit 38 references the information on the type of MAC protocols, the type of upper-layer protocols contained in the radio resource acquisition request and the like; however, the description thereof is omitted here. Further, the radio resource allocation unit 38 transmits an allocation notification to this terminal apparatus 12 from the modem unit 24 via the RF unit 20. The allocation notification is also called a radio resource allocation.

The allocation notification contains the allocated subchannel and time slots. After the above-described processing has been carried out, the radio control unit 28 causes the RF unit 20 through the modem unit 24 to perform communication with the terminal apparatus 12 to which the sub-channel has been allocated. Also, upon receipt of the instruction of a handover from the not-shown control apparatus 16 via IF unit 26, the radio resource allocation unit 38 instructs a handover to the terminal apparatus 12, via the baseband processing unit 22 and the RF unit 20. The processing carried out by the radio control unit 28 in the handover may be a known art and therefore the description thereof is omitted here.

This structure may be implemented hardwarewise by elements such as a CPU, memory and other LSIs of an arbitrary computer, and softwarewise by memory-loaded programs having communication functions or the like.

Depicted herein are functional blocks implemented by cooperation of hardware and software. Therefore, it will be obvious to those skilled in the art that the functional blocks may be implemented by a variety of manners including hardware only, software only or a combination of both.

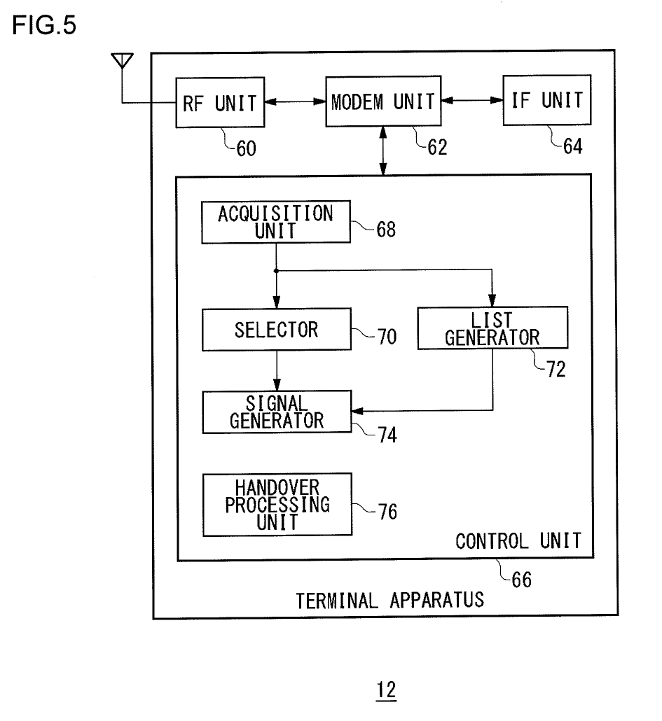

FIG. 5 shows a structure of the terminal apparatus 12. The terminal apparatus 12 includes an RF unit 60, a modem unit 62, an IF unit 64, and a control unit 66. The control unit 66 includes an acquisition unit 68, a selector 70, a list generator 72, a signal generator 74, and a handover processing unit 76.

The RF unit 60 carries out the processing corresponding to the RF unit 20 of FIG. 4, and the modem unit 62 carries out the processing corresponding to the modem unit 24 of FIG. 4 added with FFT and IFFT. Thus, the description regarding the RF unit 60 and the modem unit 62 is omitted here. The IF unit 64 has a user interface function. For example, the IF unit 64 may have buttons and the like, so that it can receive instructions from a user. The IF unit 64 outputs the thus received instructions, as signals, to the modem unit 62 and the control unit 66. The

IF unit 64 may have a display, so that the data demodulated by the modem unit 62 can be displayed.

The control unit 66 controls the entire operation of the terminal apparatus 12. The acquisition unit 68 receives broadcast signals sent from various base station apparatuses through the aforementioned control channel, via the RF unit 60 and the modem unit 62. The base station apparatuses meant here include the microcell base station apparatus 10 and the nanocell base station apparatus 50. Also, the acquisition unit 68 acquires the identification number of a base station apparatus, which is a sender, (hereinafter referred to as “base station ID”) from the broadcast signal received. Also, the acquisition unit 68 acquires a value of the received signal strength ,from the RF unit 60, measured when said broadcast signal is received. An example of the value of the received signal strength is RSSI (Received Signal Strength Indicator). Further, the acquisition unit 68 verifies the time when the broadcast signal is received. Also the acquisition unit 68 gathers the base station ID, the value of the received signal strength and the time into a single piece of information (hereinafter referred to as “base station information”) and outputs the base station information to the selector 70 and the list generator 72. Note that the acquisition unit 68 acquires the broadcast signal sent out from the a plurality of base station apparatuses by repeating the above-described processing.

The selector 70 receives the base station information on a plurality of base station apparatuses, from the acquisition unit 68. Also, the selector 70 selects a base station apparatus, having the maximum received signal strength, as one whose position is to be registered. In other words, the selector 70 selects a base station apparatus whose position registration is to be requested, from among the base station apparatuses picked up by the acquisition unit 68. In this case, the selector 70 selects a base station apparatus with no distinction between whether it is a microcell base station apparatus 10 or a nanocell base station apparatus 50. Note that this processing may be done during a predetermined period of time. The selector 70 outputs the base station ID of the selected base station apparatus to the signal generator 74.

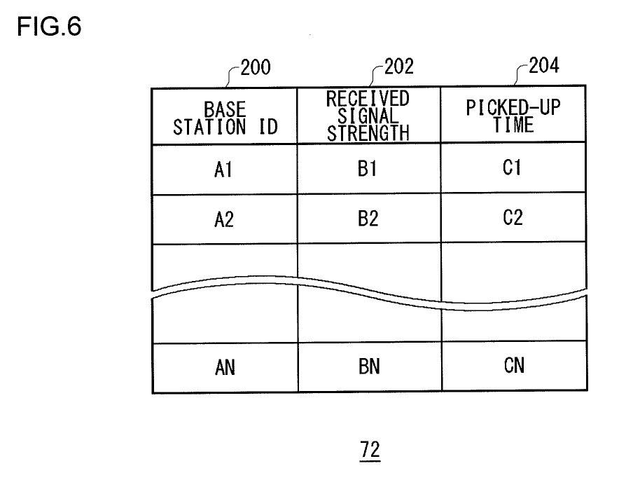

The list generator 72 receives a plurality of pieces of base station information on a plurality of base station apparatuses, from the acquisition unit 68 and gathers them together so as to generate a base station list. FIG. 6 shows a data structure of the base station list generated by the list generator 72. As shown in FIG. 6, the base station list is constituted by a base station ID column 200, a received signal strength column 202, and a picked-up time column 204. These are associated respectively with the base station ID, the value of the received signal strength, and the time. It can thus be said that the base station list is a list indicating base station apparatuses picked by the acquisition unit 68. Note that the list generator 72 generates the base station list with no distinction between whether the base station apparatus picked up thereby is a microcell base station apparatus 10 or a nanocell base station apparatus 50. Now refer back to FIG. 5.

The signal generator 74 generates a request signal for position registration. Here, the destination of the request for position registration is the base station apparatus selected by the selector 70. As described above, for the clarity of explanation, it is assumed here that a microcell base station apparatus 10 is selected by the selector 70. The signal generator 74 transmits the request signal for position registration to the microcell base station apparatus 10 via the modem unit 62 and the RF unit 60. Then the control unit 66 receives a notification indicating that the position registration has been completed, from the microcell base station apparatus 10 via the RF unit 60 and the modem unit 62. Then the signal generator 74 generates a signal containing the base station list, and transmits the signal to the microcell base station apparatus 10 via the modem unit 62 and the RF unit 60.

The handover processing unit 76 receives an instruction to perform a handover, from the microcell base station apparatus 10 via the RF unit 60 and the modem unit 62. For example, the execution of a handover to the nanocell base station apparatus 50 is given in the instruction to perform a handover. Based on the received instruction, the handover processing unit 76 gives an instruction to perform a handover to the nanocell base station apparatus 50, to the modem unit 62 and the RF unit 60. The handover processing may be a known art and therefore the description thereof is omitted here. Though the control unit 66 also makes a channel allocation request and controls the data communication, these tasks may be executed in correspondence with the above descriptions given of the microcell base station apparatus 10 and therefore the description thereof is omitted here.

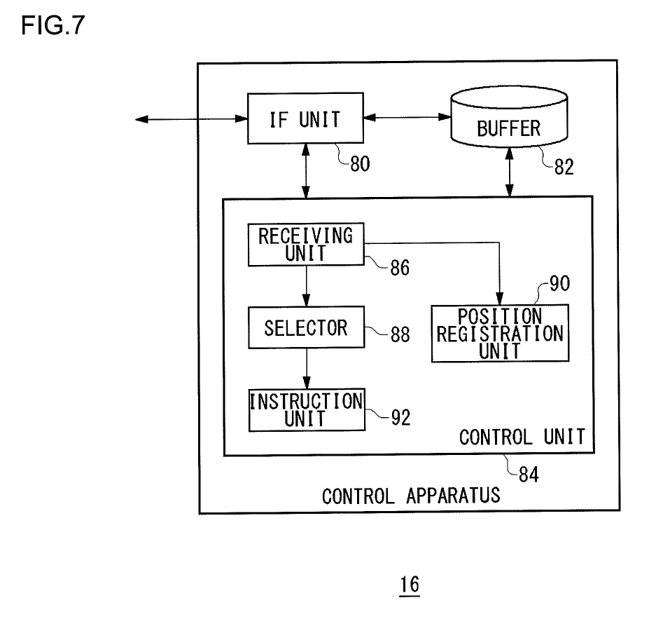

FIG. 7 shows a structure of the control apparatus 16. The control apparatus 16 includes an IF unit 80, a buffer 82, and a control unit 84. The control unit 84 includes a receiving unit 86, a selector 88, a position registration unit 90, and an instruction unit 92. The control apparatus 16 principally executes position registration and control of handover. A description will be first given of the position registration.

The IF unit 80 connects to the not-shown microcell base station apparatus 10 via the not-shown network 14. The receiving unit 86 receives the request for position registration sent from the not-shown terminal apparatus 12, via the IF unit 80. The receiving unit 86 outputs the thus received request for position registration to the position registration unit 90. The position registration unit 90 performs a processing of position registration on the terminal apparatus 12, using the known art. The position registration unit 90 stores the results of position registration in the buffer 82. The IF unit 80 transmits a position registration response to the request for position registration, to the terminal apparatus 12. It is to be noted here that the function of position registration may be included in a not-shown switching equipment or the like instead of in the control apparatus 16.

A description will now be given of the control of handover. The receiving unit 86 receives the base station list from the terminal apparatus 12 via the IF unit 80. Note that the information on the terminal apparatus 12, which is a sender, is appended to the base station list. It can be said that the base station list or the like is information attendant to the request for position registration. The receiving unit 86 outputs the received base station list and the information on the terminal apparatus 12, which is a sender, to the selector 88. On the other hand, the buffer 82 stores the subscription list indicating the nanocell base station 50 that has been subscribed beforehand to by the terminal apparatus 12.

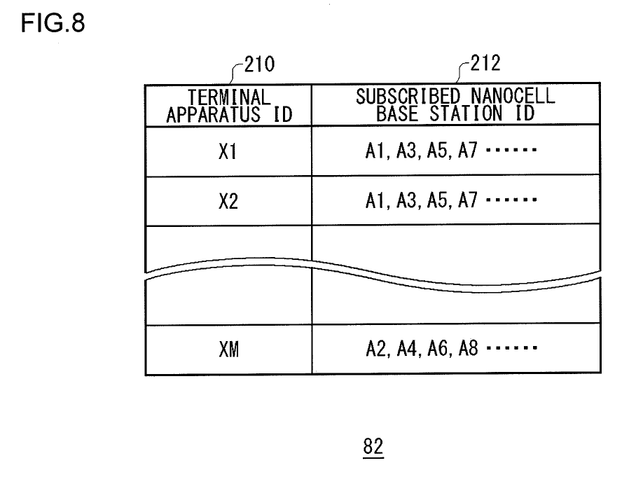

FIG. 8 illustrates a data structure of a subscription list stored in the buffer 82. As shown in FIG. 8, the subscription list is constituted by a terminal apparatus ID column 210 and a subscribed nanocell base station ID column 212. The terminal apparatus ID column 210 indicates the identification numbers given to the terminal apparatuses 12 that are to be processed. The subscribed nanocell base station ID column 212 indicates the identification numbers of the nanocell base station apparatuses 50 to which the respective terminal apparatuses 12 have already subscribed. The identification number indicated in the subscribed nanocell base station ID column 212 corresponds to the identification number indicated in the base station ID column 200 of FIG. 6. It is assumed here that the subscribed nanocell base station ID column 212 indicates all the nanocell base station apparatuses 50, to which the terminal apparatuses 12 have subscribed, irrespective of the paging area. Now refer back to FIG. 7.

The selector 88 compares the base station list received by the receiving unit 86 with the subscription list stored in the buffer 82, and selects the subscribed nanocell base station apparatus 50 which is picked up by the terminal apparatus 12. More specifically, using the information appended to the base station list, the selector 88 references the subscription list so as to extract the nanocell base station apparatus 50 to which the terminal apparatus 12 has subscribed. If there are a plurality of nanocell base station apparatuses 50 to which the terminal apparatus 12 has subscribed, the selector 88 will select the plurality of nanocell base station apparatuses 50. The selector 88 compares the base station IDs with the extracted base station ID and selects the base station ID that matches with the extracted base station ID. If a plurality of base station IDs are selected, the selector 88 will select the base station ID that corresponds to the maximum received signal strength value by referencing the received signal strength values included in the base station list. The thus selected base station ID corresponds to the subscribed nanocell base station apparatus 50 picked up by the terminal apparatus 12. The instruction unit 92 has the microcell base station apparatus 10 instruct the terminal apparatus 12 to perform a handover to the nanocell base station apparatus 50 selected by the selector 88.

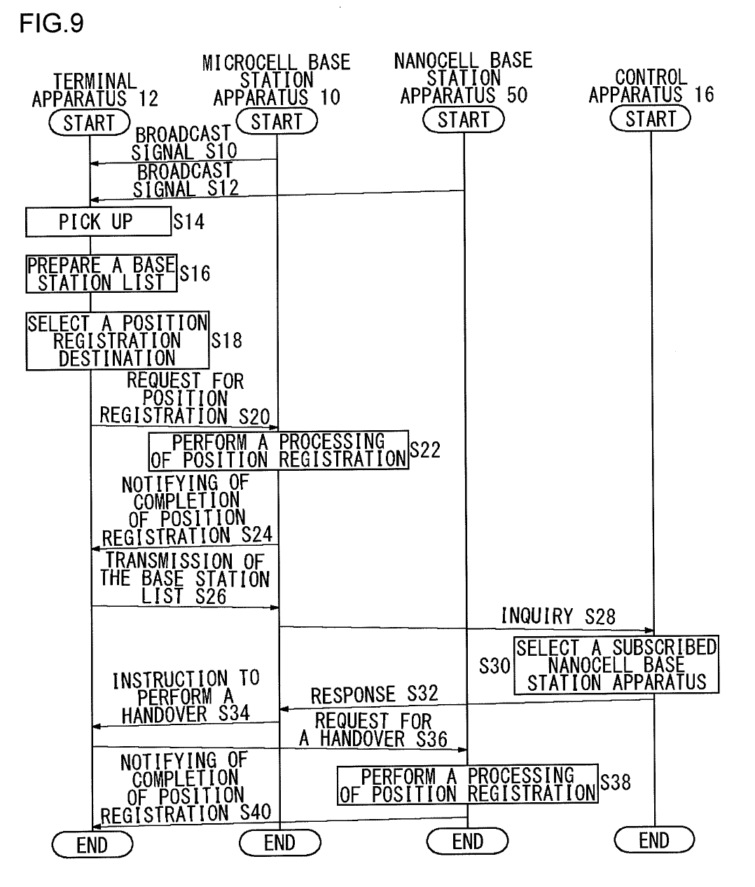

An operation of the communication system 100 structured as above will now be described. FIG. 9 is a sequence diagram showing a handover procedure in the communication system 100. The microcell base station apparatus 10 transmits a broadcast signal (S10), and the nanocell base station apparatus 50 also transmits a broadcast signal (S12). Upon receipt of the broadcast signals, the terminal apparatus 12 picks up the microcell base station apparatus 10 and the nanocell base station apparatus 50 (S14). The terminal apparatus 12 prepares a base station list (S16) and selects a base station apparatus which is a position registration destination (S18). The terminal apparatus 12 transmits a request for position registration to the microcell base station apparatus 10 (S20). The microcell base station apparatus 10 performs a processing of position registration (S22). Note that the processing of position registration is carried out by the control apparatus 16 based on a request from the microcell base station apparatus 10.

The microcell base station apparatus 10 transmits, to the terminal apparatus 12, a notification indicating that the position registration has been completed (S24). Following the notification indicating the completion of position registration, the terminal apparatus 12 transmits the base station list to the microcell base station apparatus 10 (S26). The microcell base station apparatus 10 transmits the base station list to the control apparatus 16 as an inquiry (S28). Upon receipt of the inquiry, the control apparatus 16 selects a subscribed nanocell base station apparatus 50 (S30) and transmits its result to the microcell base station apparatus 10 as a response (S32). The microcell base station apparatus 10 instructs the terminal apparatus 12 to perform a handover to the nanocell base station apparatus 50 (S34). The terminal apparatus 12 transmits a request for the handover to the nanocell base station apparatus 50 (S36). The nanocell base station apparatus 50 performs a processing of position registration (S38). Note that the processing of position registration is carried out by the control apparatus 16 based on a request from the nanocell base station apparatus 50. The nanocell base station apparatus 50 transmits, to the terminal apparatus 12, a notification indicating that the position registration has been completed (S40).

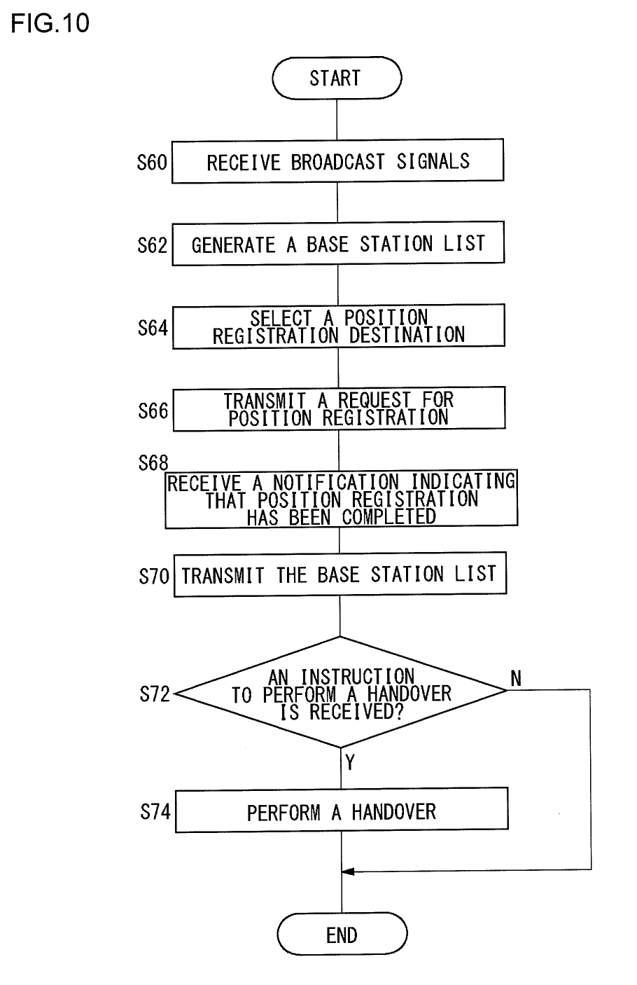

FIG. 10 is a flowchart showing a handover procedure in the terminal apparatus 12. The acquisition unit 68 receives the broadcast signals via the RF unit 60 and the modem unit 62 (S60). The list generator 72 generates a base station list (S62). The selector 70 selects a base station apparatus which is the position registration destination (S64). The signal generator 74 transmits a request for position registration via the modem unit 62 and the RF unit 60 (S66). The signal generator 74 receives a notification indicating that the position registration has been completed, via the RF unit 60 and the modem unit 62 (S68). The signal generator 74 transmits the base station list via the modem unit 62 and the RF unit 60 (S70). If the handover processing unit 76 receives an instruction to perform a handover (Y of S72), the handover processing unit 76 will perform a handover (S74). If, on the other had, the handover processing unit 76 does not receive the instruction to perform a handover (N of S72), the handover processing will be terminated.

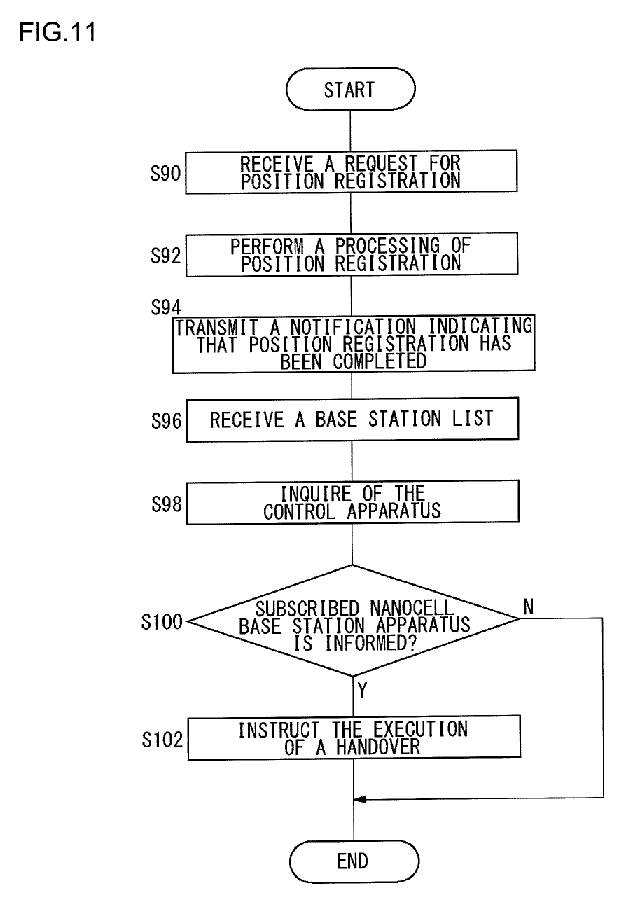

FIG. 11 is a flowchart showing a handover procedure in the microcell base station apparatus 10. As the RF unit 20 and the baseband processing unit 22 receive the request for position registration from the terminal apparatus 12 (S90), the IF unit 26 has the control apparatus 16 perform a processing of position registration (S92). As the control apparatus 16 receives from the control apparatus 16 a notification indicating that the position registration has been completed, the baseband processing unit 22 and the RF unit 20 transmit the notification indicating that the position registration has been completed, to the terminal apparatus 12 (S94). As the RF unit 20 and the baseband processing unit 22 receive a base station list from the terminal apparatus 12 (S96), the IF unit 26 transmits an inquiry to the control apparatus 16 (S98). As the IF unit 26 is informed of an already-subscribed nanocell base station apparatus 50, by the control apparatus 16 (Y of S100), the radio control unit 28 instructs the terminal apparatus 12 to perform a handover, via the baseband processing unit 22 and the RF unit 20 (S102). If the IF unit 26 is not informed of any subscribed nanocell base station apparatus 50, by the control apparatus 16 (N of S100), the processing will be terminated (N of S100).

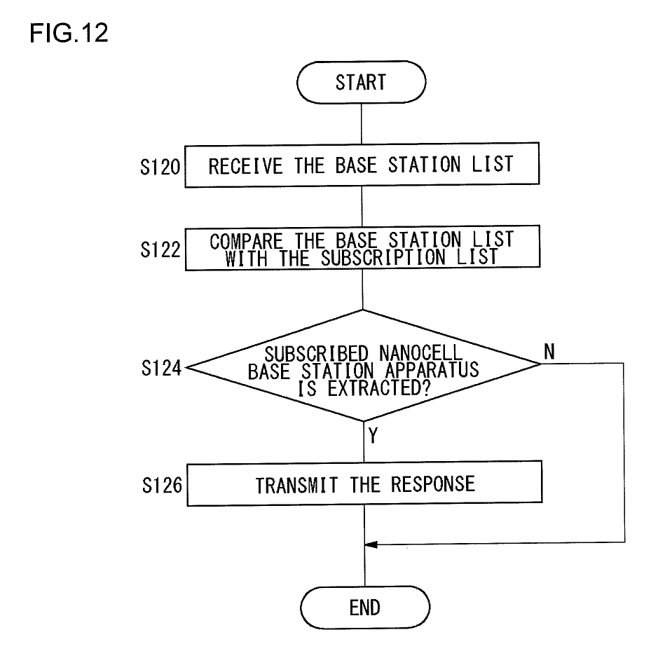

FIG. 12 is a flowchart showing a handover procedure in the control apparatus 16. The receiving unit 86 receives the base station list as the inquiry (S120). The selector 88 compares the base station list with the subscription list (S122). If the selector 88 extracts the already-subscribed nanocell base station apparatus 50 (Y of S124), the instruction unit 92 will transmit a response (S126). If, on the other hand, the selector 88 does not extract the subscribed nanocell base station apparatus 50 (N of S124), the processing will be terminated.

A description is now given of modifications. In the above-described exemplary embodiments, the control apparatus 16 stores the subscription list. This subscription list contains information on all the nanocell base station apparatuses 50 to which the terminal apparatuses 12 have subscribed beforehand. However, to reduce the size of the subscription list stored in each control apparatus 16, each control apparatus 16 may store the subscription list that contains only nanocell base station apparatuses 50 installed in its own paging area. To achieve this, each base station apparatus includes information, on a paging area belonging to the each own base station apparatus, in the broadcast signal. When generating the base station list, the list generator 72 in the terminal apparatus 12 includes the information, on the paging area associated with each base station apparatus, in the base station list. The signal generator 74 transmits such a base station list.

The buffer 82 in the control apparatus 16 stores the subscription list. This subscription list contains only the nanocell base station apparatus 50 belonging to the paging area associated with the control apparatus 16. The buffer 82 stores information on a paging area and a list showing correspondence between the paging area and the control apparatus 16 belonging to the paging area (hereinafter referred to as “correspondence list”). The receiving unit 86 receives the base station list. As described above, this base station list contains the information on a paging area associated with each base station apparatus. Based on the information on a paging area, the selector 88 extracts the base station ID included in its own paging area, from the base station list. Also, the selector 88 compares the extracted base station ID against the IDs listed in the subscription list, using the subscription list.

If, on the other hand, base station IDs belonging to other paging areas are contained in the base station list, the selector 88 will identify such other control apparatuses 16 by referencing the correspondence list. Also, the selector 88 transmits the base station IDs to the thus identified other control apparatuses 16 via the

IF unit 80 so as to have the other control apparatuses 16 verify whether a base station apparatus corresponding to the base station ID is an already-subscribed nanocell base station apparatus 50 or not. That is, the selector 88 make inquires to the control apparatuses 16 in other paging areas so as to compare the base station ID with the IDs listed in the subscription list. As a result of the above-described processing, the selector 88 selects the already-subscribed nanocell base station apparatus 50.

By employing the exemplary embodiments of the present invention, a terminal apparatus performs a handover to a nanocell base station apparatus, based on the base station list generated by the terminal apparatus and the subscription list stored in advance, so that communications can be performed between the terminal apparatus and the nanocell base station apparatus. Also, even if the terminal apparatus selects a microcell base station apparatus, a handover will be made to the nanocell base station apparatus, so that the nanocell base station apparatus can be selected preferentially over the microcell base station apparatus.

Also, there is no need for the terminal apparatus to keep track of already-subscribed nanacell base station apparatuses, thus readily realizing preferential selection of a nanocell base station apparatus over a microcell base station apparatus. Also, since the subscription list is stored in the control apparatus and is not stored in the terminal apparatus, the security can be enhanced. Also, the terminal apparatus generates the base station list and merely gathers a result regarding the base station apparatuses picked up, so that the increase in the processing amount can be prevented. Also, it suffices that the control apparatus stores the subscription list for the nanocell base station apparatuses belonging to its own paging area, so that the increase in the size of the subscription list can be prevented.

The present invention has been described based on the exemplary embodiments. The exemplary embodiments are intended to be illustrative only, and it is understood by those skilled in the art that various modifications to constituting elements and processes could be developed and that such modifications are also within the scope of the present invention.

In the exemplary embodiments of the present invention, the control apparatus 16 is so provided in each paging area as to control a given paging area. However, this should not be considered as limiting and, for example, a single control apparatus 16 only may be provided as a central controlling unit. In this case, the control apparatus 16 manages the microcell base station apparatuses 10 and the nanocell base station apparatuses 50 located within a service operating area. According to this modification, the subscription lists are centrally controlled and stored in one place, so that the subscription lists can be managed with ease.

Also, the control apparatus 16 may be installed in each microcell base station apparatus 10. That is, the processing performed by the control apparatus 16 is done by the microcell base station apparatus 10. According to this modification, the already-subscribed nanocell base station apparatus 50 are selected by the microcell base station apparatus 10, so that the traffic volume on the network 14 can be reduced.

In the modifications of the exemplary embodiments, the terminal apparatus 12 transmits the request signal for position registration to the microcell base station apparatus 10 and then transmits the base station list to said microcell base station apparatus 10. However, this should not considered as limiting and, for example, the terminal apparatus 12 may first transmit the base station list to the microcell base station apparatus 10 and then transmit the request signal for position registration to said microcell base station apparatus 10. Also, the terminal apparatus 12 may transmit the request signal for position registration and the base station list as a single signal to the microcell base station apparatus 10. According to this modification, the degree of freedom in procedure can be improved.

### INDUSTRIAL APPLICABILITY

The present invention promptly readily realizes preferential selection of a nanocell base station apparatus over a microcell base station apparatus.

What is claimed is:

1. A control apparatus, comprising:
a receiving unit configured to receive a first list showing base station apparatuses picked up by a terminal apparatus, the first list being attendant to a request for position registration sent from the terminal apparatus to a first base station apparatus;
a selector configured to select a subscribed second base station apparatus picked up by the terminal apparatus by comparing the first list received by the receiving unit with a second list showing base station apparatuses subscribed to by the terminal apparatus; and
an instructing unit configured to have the first base station apparatus instruct the terminal apparatus to perform a handover to the second base station apparatus selected by the selector.

2. A control apparatus according to claim 1, wherein the first list received by the receiving unit contains information on paging areas corresponding to the respective base station apparatuses, and
wherein the selector performs a comparison using the second list corresponding to predetermined paging areas; when the first list includes a base station apparatus belonging to another paging area, the selector performs a comparison by inquiring of a control apparatus in the another paging area.

3. A terminal apparatus for performing position registration, the terminal apparatus comprising:
a selector configured to select a first base station apparatus whose position registration is to be requested, from among picked-up base station apparatuses;
a transmitter configured to require the position registration of the first base station apparatus selected by the selector and configured to transmit a first list showing the picked-up base station apparatuses;
a receiver configured to receive an instruction to perform a handover from the first base station apparatus, whose position registration has been requested by the transmitter, to a second base station apparatus, the second base station apparatus having been selected as a result of comparison between the first list and a second list showing base station apparatuses to which the terminal apparatus have subscribed; and
a handover processing unit configured to perform a handover to the second base station apparatus, based on the instruction received by the receiver.

4. A terminal apparatus according to claim 3, wherein the first list transmitted from the transmitter contains information on a paging area corresponding to each of the picked-up base station apparatuses.

5. A handover method, comprising:
receiving a first list showing base station apparatuses picked up by a terminal apparatus, the first list being attendant to a request for position registration sent from the terminal apparatus to a first base station apparatus;
selecting a subscribed second base station apparatus picked up by the terminal apparatus, by comparing the received first list with a second list showing base station apparatuses subscribed to by the terminal apparatus; and
causing the first base station apparatus to instruct the terminal apparatus to perform a handover to the selected second base station apparatus.

6. A handover method, comprising:
selecting a first base station apparatus whose position registration is to be requested, from among picked-up base station apparatuses;
requiring the position registration of the selected first base station apparatus and transmitting a first list showing the picked-up base station apparatuses;
receiving an instruction to perform a handover from the first base station apparatus, whose position registration has been requested, to a second base station apparatus, the second base station apparatus having been selected as a result of comparison between the first list and a second list showing base station apparatuses to which the terminal apparatus have subscribed; and
performing a handover to the second base station apparatus, based on the received instruction.
